(19) United States
(12) Patent Application Publication
(10) Pub. No.: US 2014/0069563 A1
(43) Pub. Date: Mar. 13, 2014

(54) ARAMID/POLYKETONE COMPOSITE TEXTILE CORD

(71) Applicant: Christophe Le Clerc, Clermont-Ferrand (FR)

(72) Inventor: Christophe Le Clerc, Clermont-Ferrand (FR)

(73) Assignees: MICHELIN RECHERCHE ET TECHNIQUE S.A., GRANGES-PACCOT (CH); COMPAGNIE GENERALE DES ETABLISSEMENTS MICHELIN, CLERMONT-FERRAND (FR)

(21) Appl. No.: 14/113,474

(22) PCT Filed: Apr. 25, 2012
(86) PCT No.: PCT/EP2012/057546

§ 371 Date: Nov. 20, 2013

(30) Foreign Application Priority Data
Apr. 28, 2011 (FR) 1153632

(51) Int. Cl. B60C 9/00; D02G 3/48

(52) U.S. Cl. CPC B60C 9/005; D02G 3/48
USPC 152/527; 57/255; 152/556

(57) ABSTRACT

Aramid/polyketone composite textile cord comprising at least one aramid multifilament strand and at least one polyketone multifilament strand that are twisted together, the constituent individual filaments of the aramid multifilament strand being twisted according to a twist factor K₁ and the constituent individual filaments of the polyketone multifilament strand being twisted according to a twist factor K₂, characterized in that in said cord:
the aramid/polyketone weight ratio is greater than 1.5;
the K₂/K₁ ratio is greater than 1.10.

This textile cord can advantageously be used as a reinforcer in tyres, in particular in the belt or in the carcass reinforcement of these tyres.

### FIELD OF THE INVENTION

The present invention relates to textile reinforcers that can be used especially for reinforcing rubber articles such as tyres, in particular for reinforcing crown reinforcements or carcass reinforcements of such tyres.

It relates more particularly to textile folded yarns or cords of composite or hybrid type, also sometimes referred to as “bi-modulus” materials, consisting of textile materials that have tensile moduli, and more generally mechanical properties, which are significantly different from one material to the other.

### PRIOR ART

The hybrid textile folded yarns or cords, consisting of two different textile materials, are well known; they have been used for a long time for improving certain usage properties, owing in particular to improved compromises between mechanical properties, thermal properties and fatigue strength.

The most widely used up until now for reinforcing tyres are hybrid cords of aramid-nylon type, comprising both aramid strands and nylon strands, in particular constructions containing two strands (aramid/nylon) or even containing three strands (aramid/aramid/nylon). Such cords and their particular constructions have been described in detail in a large number of patent documents, for example in EP 335 588, EP 467 585, U.S. Pat. No. 3,977,172, U.S. Pat. No. 4,155,394, U.S. Pat. No. 5,558,144, EP 1 075 968 or U.S. Pat. No. 6,533,012, U.S. Pat. No. 6,799,618, WO 02/085646 or U.S. Pat. No. 7,905,265.

These hybrid aramid-nylon cords are not however without drawbacks.

Firstly, the drawback of nylon is that it has a low initial tensile modulus, particularly at high temperature (typically 150° C. and above), which may lead to a degradation of the rolling performance of the tyres under particularly high temperature conditions. Moreover, the thermal shrinkage of the nylon is relatively high, which may be the cause of difficulties in the satisfactory dimensioning of tyre casings during their various steps of manufacture then of curing.

Lastly, the great differences in tensile modulus between the two types of materials, aramid and nylon, result, as is known, in final modulus/initial modulus ratios that are particularly high, admittedly sometimes targeted, especially for use as crown reinforcement of tyres, but which may also be detrimental in certain cases, in particular for certain uses as carcass reinforcement.

Thus, for certain applications, tyre designers are seeking materials that can be advantageously substituted for nylon in the hybrid textile cords as described above.

In particular, application WO 2008/092712 (or US 2009/0283195) has proposed using a polyketone fibre in place of a nylon fibre, for the manufacture of aramid/polyketone hybrid cords intended for wrapping belts of tyres capable of running at high speed. These cords are characterized by a reduced thermal shrinkage, which makes it possible to better control the dimensioning of the tyres during the various steps of their manufacture.

Experimentation however shows that the hybrid cords described in that application, having conventional construction, namely consisting of a single aramid strand and of a single polyketone strand, preferably at the same linear density, which are twisted with an identical twist, may be further optimized.

### BRIEF DESCRIPTION OF THE INVENTION

In the course of their research, the applicant companies have found a novel aramid/polyketone composite textile cord, the specific construction of which unexpectedly makes it possible to improve the compromise of the mechanical, breaking strength, initial modulus and tenacity properties of the aramid/polyketone composite textile cords.

Thus, according to a first subject, the present invention relates to an aramid/polyketone composite textile cord that can be used in particular for reinforcing tyres, comprising at least one aramid multifilament strand and at least one polyketone multifilament strand that are twisted together, the constituent individual filaments of the aramid multifilament strand being twisted according to a twist factor K₁ and the constituent individual filaments of the polyketone multifilament strand being twisted according to a twist factor K₂, characterized in that in said cord:
the aramid/polyketone weight ratio is greater than 1.5;
the K₂/K₁ ratio is greater than 1.10.

The invention also relates to the use of such a textile cord as a reinforcing element for articles or semi-finished products made of rubber, such as tyres, and also to these rubber articles, semi-finished products and tyres themselves both in the raw state (that is to say before curing or vulcanization) and in the cured state (after curing).

The tyres of the invention, in particular, may be intended for motor vehicles of passenger, 4×4 or “SUV” (Sport Utility Vehicle) type, but also for two-wheeled vehicles such as motorcycles, or for industrial vehicles chosen from vans, “heavy” vehicles, i.e., underground trains, buses, road transport vehicles (lorries, tractors, trailers) and off-road vehicles, agricultural or civil engineering machines, aircraft and other transport or handling vehicles.

The textile cord of the invention is very particularly intended to be used in crown reinforcements (or belts) such as in carcass reinforcements of tyres for the vehicles described above.

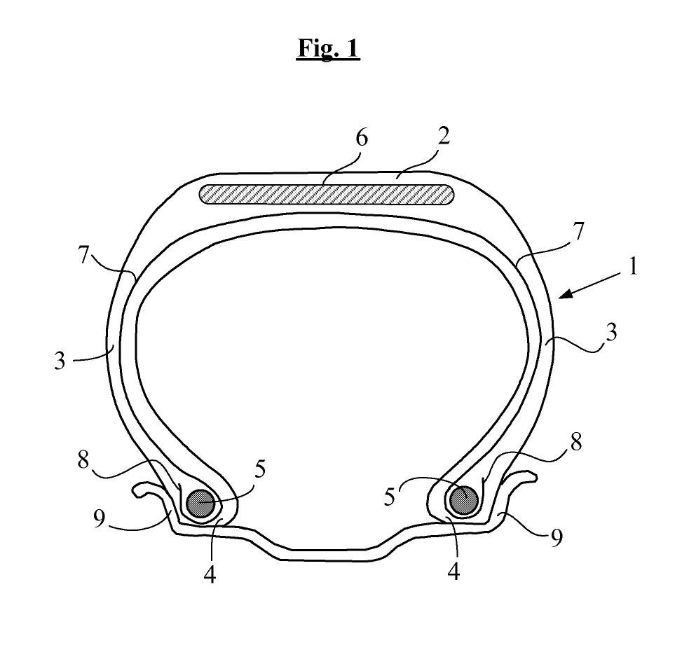

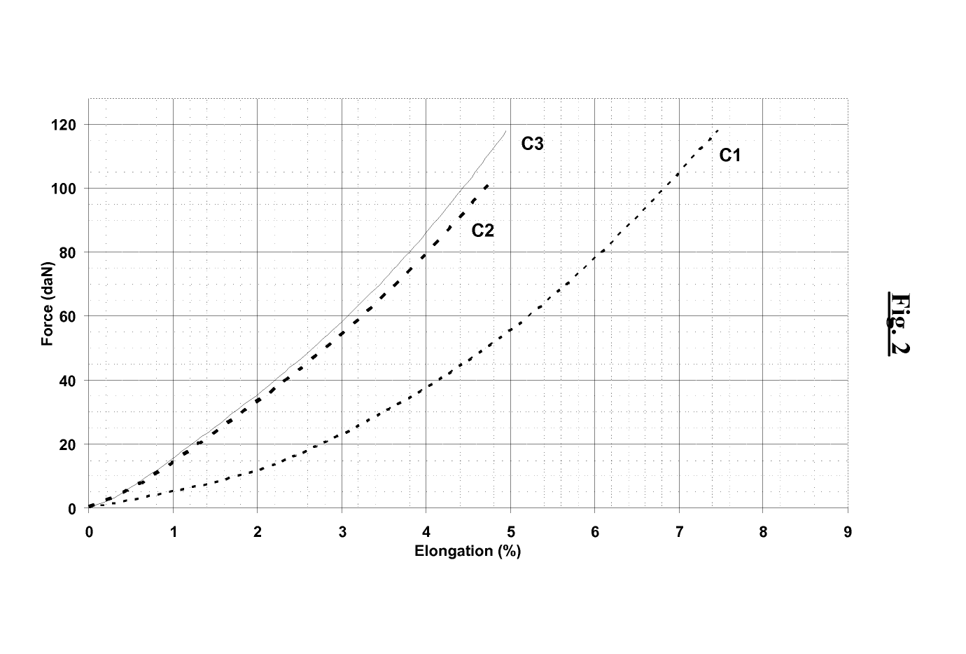

The invention and its advantages will be readily understood in the light of the detailed description and exemplary embodiments which follow, and also FIGS. 1 and 2 relating to these embodiments, which schematically show (unless otherwise indicated, not to a specific scale):
in radial section, an example of a pneumatic tyre in accordance with the invention, incorporating a textile cord according to the invention (FIG. 1);
stress-elongation curves recorded on composite textile cords in accordance or not in accordance with the invention (FIG. 2).

### DETAILED DESCRIPTION OF THE INVENTION

In the present application, unless expressly indicated otherwise, all the percentages (%) shown are percentages by weight.

Any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

The textile cord or folded yarn of the invention is therefore an aramid/polyketone composite textile cord comprising at least one (i.e. one or more) aramid multifilament strand (or fibre) and at least one (i.e. one or more) polyketone multifilament strand (or fibre) that are twisted together, the constituent individual filaments of the aramid multifilament strand being twisted according to a twist factor K₁ and the constituent individual filaments of the polyketone multifilament strand being twisted according to a twist factor K₂.

For an optimized compromise of its mechanical, breaking strength, initial modulus and tenacity properties, this textile cord of the invention has the following two essential features:
the aramid/polyketone weight ratio is greater than 1.5;
the K₂/K₁ ratio is greater than 1.10.

It is recalled, in a well-known manner, that a fibre referred to as an “aramid” fibre is a fibre of linear macromolecules formed from aromatic groups bonded together by amide bonds, at least 85% of which are directly bonded to two aromatic rings, and more particularly poly(p-phenylene terephthalamide) (or PPTA) fibres, manufactured for a very long time from optically anisotropic spinning compositions.

The term “polyketone” (abbreviated to PK) refers to a thermoplastic polymer obtained by polycondensation of ethylene and carbon monoxide. Polyketone fibres have themselves also been described in a very large number of patent documents (see, for example, EP 310 171, EP 456 306, EP 1 925 467, WO 2002/068738 or U.S. Pat. No. 6,818,728, US 2007/0017620, US 2009/0266462).

The aramid/polyketone weight ratio, as its name indicates, represents the ratio of the total weight of aramid material (therefore total weight of the aramid strand or strands, if there are several) to the total weight of polyketone material (therefore total weight of the polyketone strand or strands, if there are several).

In accordance with the invention, this weight ratio is greater than 1.5, preferably greater than 2.0, more preferably still greater than 3.0.

As regards the factor K, it will be recalled here that, in a textile cord, the twist factor of a multifilament strand (more precisely of the constituent individual filaments of said strand) is expressed according to the following relationship:

K=(twist in turns/metre)×[linear density of the strand (in tex)/(1000.ρ)]^{1/2}

in which the twist is expressed in turns per metre of strand, the linear density of the strand is expressed in tex (weight in grams of 1000 metres of strand), and finally ρ is the density (in g/cm³) of the constituent material of the strand (around 1.44 for aramid, 1.14 for nylon and 1.30 for polyketone).

In accordance with the invention, for an optimal mechanical behaviour of the cord of the invention up to the highest elongation levels, the K₂/K₁ ratio is greater than 1.10, preferably greater than 1.20, more preferably still greater than 1.25.

The textile cord of the invention may comprise one or more aramid multifilament strands. Preferably, the linear density of each aramid strand is between 100 and 450 tex, more preferably between 150 and 400 tex. The twist of each aramid strand is preferably between 150 and 400 turns per metre, more preferably between 200 and 350 turns per metre.

The textile cord of the invention may comprise one or more polyketone multifilament strands. Preferably, the linear density of each polyketone strand is between 100 and 400 tex, more preferably between 150 and 250 tex. The twist of each polyketone strand is preferably between 200 and 600 turns per metre, more preferably between 350 and 500 turns per metre.

According to one particularly preferred embodiment, the composite textile cord of the invention comprises two aramid strands and a single polyketone strand.

According to another preferred embodiment, the cord of the invention has an initial tensile modulus, measured at 20° C., which is greater than 1000 cN/tex, preferably between 1300 and 2000 cN/tex. According to another preferred embodiment, which may or may not be combined with the preceding one, the cord of the invention has a final tensile modulus, measured at 20° C., which is greater than 3000 cN/tex, preferably between 3500 and 4000 cN/tex.

According to another preferred embodiment, the ratio of the final modulus of the cord to the initial modulus of the cord, measured at 20° C., is less than 4, more preferably between 1.0 and 3.0. Such a feature gives the tyres in particular the possibility of retaining a very good dimensional stability, irrespective of the speed or loading conditions of these tyres.

According to another preferred embodiment, the initial tensile modulus of the cord, measured at 180° C., is greater than 300 cN/tex, more preferably between 500 and 1500 cN/tex. The tenacity of the cord, measured at 20° C., is preferably greater than 120 cN/tex, more preferably between 125 and 150 cN/tex.

All the mechanical properties mentioned above are well known to a person skilled in the art, deduced from force-elongation curves.

According to another preferred embodiment, the composite textile cord of the invention has a thermal shrinkage (denoted by TS) of its length, after 2 minutes at 185° C., under a pretension of 0.5 cN/tex, which is between 0.2% and 2.5%, more preferably between 0.5% and 2%.

Such a preferred feature has proved optimal for the stability of manufacture and of dimensioning of tyre casings, in particular during the curing and cooling phases of the latter.

TS is measured, unless otherwise specified, according to the ASTM D1204-08 standard, for example with a machine of “TESTRITE” type. At constant length, the maximum of the shrinkage force (denoted by F_{S}) during the above test (2 min at 185° C.) is also measured. The result is expressed in cN/tex, therefore related to the linear density of the sample of cord tested. This shrinkage force, over the composite textile cord of the invention, is preferably between 1 and 2.5 cN/tex, more preferably between 1.4 and 2.0 cN/tex; a high shrinkage force is particularly favourable to the wrapping capacity of the textile cords with respect to the crown reinforcement of the tyre when the latter warms up under high running speed.

### EXEMPLARY EMBODIMENTS OF THE INVENTION

The textile cord of the invention can advantageously be used for the reinforcement of tyres of all types of vehicles, in particular of motorcycles, passenger vehicles or industrial vehicles such as “heavy” vehicles, civil engineering machines, aircraft and other transport or handling vehicles.

By way of example, FIG. 1 represents very schematically (not to a specific scale) a radial section of a tyre in accordance with the invention for a passenger type vehicle.

This tyre 1 comprises a crown 2 reinforced by a crown reinforcement or belt 6, two sidewalls 3 and two beads 4, each of these beads 4 being reinforced with a bead wire 5. The crown 2 is surmounted by a tread (not shown in this schematic figure). A carcass reinforcement 7 is wound around the two bead wires 5 in each bead 4, the turn-up 8 of this reinforcement 7 lying for example towards the outside of the tyre 1, which here is shown fitted onto its rim 9.

The carcass reinforcement 7 consists, as is known per se, of at least one rubber ply reinforced by textile cords, referred to as “radial” textile cords, that is to say that these cords are arranged practically parallel to one another and extend from one bead to the other so as to make an angle of between 80° and 90° with the circumferential median plane (the plane perpendicular to the rotation axis of the tyre, which is located at mid-distance from the two beads 4 and passes through the middle of the crown reinforcement 6).

The belt 6 consists for example, as is known per se, of at least two superposed and crossed rubber plies referred to as “working plies” or “triangulation plies”, reinforced with metal cords positioned substantially parallel to one another and inclined relative to the circumferential median plane, it being possible for these working plies to be optionally combined with other rubber plies and/or fabrics. The prime role of these working plies is to give the pneumatic tyre a high cornering stiffness. The belt 6 also comprises, in this example, a rubber ply referred to as a “hooping ply” reinforced by “circumferential” reinforcing threads, that is to say that these reinforcing threads are positioned substantially parallel to one another and extend substantially circumferentially around the pneumatic tyre so as to form an angle preferably within a range from 0 to 10° with the circumferential median plane. It is recalled that the prime role of these circumferential reinforcing threads is to withstand the centrifugation of the crown at high speed.

This tyre 1 of the invention has, for example, the essential feature that at least the hooping ply of its belt (6) and/or its carcass reinforcement (7) comprises a textile cord according to the invention. According to another possible exemplary embodiment of the invention, it is for example the bead wires (5) that could consist, completely or partly, of a textile cord according to the invention.

The rubber compositions used for these plies are conventional compositions for calendering textile reinforcers, typically based on natural rubber, on carbon black, on a vulcanization system and on standard additives. The adhesion between the composite textile cord of the invention and the rubber layer that coats it is provided, for example, by a standard adhesive of RFL type.

FIG. 2 itself reproduces force-elongation curves, denoted by C1, C2 and C3, recorded on composite textile cords in the sized state, in accordance or not in accordance with the invention, which can be used in the examples of tyres described previously.

The curve C1 corresponds to a control composite textile cord denoted by C-I: of construction denoted by A/A/N (for aramid/aramid/nylon), it consists of two aramid multifilament strands (initial linear density of each strand equal to 334 tex) and of a nylon multifilament strand (initial linear density equal to 188 tex) which are twisted together at 230 turns/metre.

The curve C2 corresponds to another control composite textile cord denoted by C-II: of construction denoted by A/A/P (for aramid/aramid/polyketone), it consists of two aramid multifilament strands (initial linear density of each strand equal to 334 tex) and of a polyketone multifilament strand (initial linear density equal to 167 tex) which are twisted together at 230 turns/metre. The construction of this cord C-II is similar to that of the cord C-I, that is to say that the various strands are twisted to an identical twist, as described in particular in application WO 2008/092712 cited in the introduction of the present description.

Finally, the curve C3 corresponds to a textile cord in accordance with the invention denoted by C-III: also of A/A/P construction, it consists of two aramid multifilament strands (initial linear density of each strand equal to 334 tex) and of a polyketone multifilament strand (initial linear density equal to 167 tex), which are twisted together, on the one hand at 230 turns/metre as regards the two aramid strands, and on the other hand at 400 turns/metre as regards the polyketone strand.

For the manufacture of the above cords by twisting, it will be recalled here simply, in a manner well known to a person skilled in the art, that each constituent strand of the final cord is firstly individually twisted upon itself in a given direction (for example, S-twisting of 230 turns per metre of strand) during a first step, then that the strands thus twisted upon themselves are then twisted together in the opposite direction (for example, Z-twisting of 230 turns per metre of strand) in order to obtain the final textile cord.

The specificity of the cord of the invention (C-III), in comparison with the two control cords (C-I and C-II), is that the polyketone strand is much more twisted upon itself than the two aramid strands, during the first step. This results, in the final cord, in a pronounced twist imbalance: in the end, in the manufactured finished cord, the two aramid strands are balanced in terms of twisting (no or virtually no residual twisting over the aramid filaments themselves in the cord) whereas the polyketone strand is still overtwisted upon itself (residual twisting of 170 turns per metre over the PK filaments themselves). Owing to this construction, the ratio of the twist factors (K₂/K₁) is very substantially greater than 1.10, in this case, in this example, equal to around 1.29.

The single appended table summarizes the construction and the respective properties of the three types of composite textile cords.

All the mechanical properties indicated are measured on sized textile cords (i.e. textile cords that are ready to use, or else that are extracted from the rubber article that they reinforce) having been subjected to prior conditioning; the expression “prior conditioning” is understood to mean the storage of the cords (after drying) for at least 24 hours, before measurement, in a standard atmosphere according to the European standard DIN EN 20139 (temperature of 20° C.±2° C.; hygrometry of 65%±2%).

The linear density of the individual strands or of the cords is determined over at least three samples, each corresponding to a length of 50 m, by weighing this length; the linear density is given in tex (weight in grams of 1000 m of product−reminder: 0.111 tex is equal to 1 denier).

The tensile mechanical properties (tenacity, initial modulus, elongation at break) are measured in a known manner using an Instron tensile test machine. The samples tested are subjected to a tensile stress over an initial length of 400 mm at a nominal speed of 200 mm/min, under a standard pretension of 0.5 cN/tex. All results given are an average of 10 measurements.

The tenacity (breaking strength divided by the linear density) and the tensile moduli (initial modulus and final modulus) are indicated in cN/tex or centinewton per tex (as a reminder, 1 cN/tex is equal to 0.11 g/den (grams per denier)). The initial modulus is defined as the slope of the linear portion of the force-elongation curve which occurs just after a standard pretension of 0.5 cN/tex. The final modulus is defined as the slope of the linear portion of the force-elongation curve which occurs just after breakage (end of the force-elongation curve). The elongation at break is indicated as a percentage.

On reading this table, as illustrated furthermore by the appearance of the corresponding tensile curves (curve C3 compared to curves C1 and C2), the following points are noted in particular:
firstly, and as expected, the hybrid cords C-II and C-III, based on polyketone, have thermal properties that are substantially improved with respect to the nylon-based hybrid cord: greater initial modulus at high temperature (180° C.), lower thermal shrinkage and greater shrinkage force;
only the cord of the invention C-III, in which the aramid/polyketone weight ratio is much greater than 1.5 (equal to 4.0 in this example), has a coefficient K₂ greater than K₁ (K₂/K₁ ratio equal to 1.29 in this example), therefore a marked twist imbalance;
this twist imbalance significantly improves the breaking strength (BS) and tenacity (Te) properties at 20° C., compared to the control cord C-II;
moreover, compared to the aramid-nylon reference cord (C-I), the specific construction of the cord of the invention C-III makes it possible to maintain the breaking strength while significantly reducing the final modulus/initial modulus ratio;
lastly, the cord in accordance with the invention is the one that has the highest tenacity.

In conclusion, owing on the one hand to a marked twist imbalance (K₂/K₁>1.10) between the aramid and polyketone strands and owing on the other hand to a sufficient (aramid/polyketone) weight ratio, it is possible to improve the compromise of the mechanical properties, in particular breaking strength, initial modulus and tenacity (at 20° C.), of the aramid/polyketone composite textile cords, while giving the latter values of the initial modulus at high temperature which are substantially greater than those available on standard composite textile cords of aramid/nylon type.

TABLE
Construction and properties of the composite textile cords tested:

| Composite cord no.: | C-I | C-II | C-III |
|---|---|---|---|
| Force-elongation curve no.: | C1 | C2 | C3 |
| Nature of the strands: | A/A/N | A/A/P | A/A/P |
| Linear density of the strands | 334/334/188 | 334/334/167 | 334/334/167 |
| (in tex) | | | |
| Linear density of the cord | 960 | 940 | 925 |
| (in tex) | | | |
| Twist of the strands | 230/230/230 | 230/230/230 | 230/230/400 |
| (in turns/m) | | | |
| K₁/K₁/K₂ | 111/111/93 | 111/111/82 | 111/111/143 |
| K₂/K₁ | 0.84 | 0.74 | 1.29 |
| BS (breaking strength in daN) | 116 | 102 | 118 |
| (20° C.) | | | |
| Te (tenacity in cN/tex) | 120 | 108 | 128 |
| (20° C.) | | | |
| Mi (initial modulus in cN/tex) | 490 | 1595 | 1620 |
| (20° C.) | | | |
| Mf (final modulus in cN/tex) | 2890 | 3065 | 3750 |
| (20° C.) | | | |
| Mf/Mi | 5.9 | 1.9 | 2.3 |
| TS (thermal shrinkage %) | 1.6 | 0.6 | 0.6 |
| (185° C.) | | | |
| F_{S} (shrinkage force in cN/tex) | 0.96 | 1.70 | 1.73 |
| (185° C.) | | | |
| Mi (initial modulus in cN/tex) | 149 | 940 | 960 |
| (180° C.) | | | |

1-19. (canceled)

20. An aramid/polyketone composite textile cord useable for reinforcing a tyre, the textile cord comprising:
at least one aramid multifilament strand; and
at least one polyketone multifilament strand,
wherein the at least one aramid multifilament strand and the at least one polyketone multifilament strand are twisted together,
wherein constituent individual filaments of the at least one aramid multifilament strand are twisted according to a twist factor K₁, and constituent individual filaments of the at least one polyketone multifilament strand are twisted according to a twist factor K₂,
wherein an aramid/polyketone weight ratio is greater than 1.5, and
wherein a K₂/K₁ ratio is greater than 1.10.

21. The textile cord according to claim 20, wherein the K₂/K₁ ratio is greater than 1.20.

22. The textile cord according to claim 20, wherein a linear density of each aramid multifilament strand is between 100 and 450 tex.

23. The textile cord according to claim 20, where a linear density of each polyketone multifilament strand is between 100 and 400 tex.

24. The textile cord according to claim 20, wherein each aramid multifilament strand is twisted between 150 and 400 turns per meter.

25. The textile cord according to claim 20, wherein each polyketone multifilament strand is twisted between 200 and 600 turns per meter.

26. The textile cord according to claim 20, wherein the textile cord includes two aramid strands and one polyketone strand.

27. The textile cord according to claim 20, wherein the aramid/polyketone weight ratio is greater than 2.0.

28. The textile cord according to claim 20, wherein an initial tensile modulus of the textile cord, measured at 20° C., is greater than 1000 cN/tex.

29. The textile cord according to claim 20, wherein a final tensile modulus of the textile cord, measured at 20° C., is greater than 3000 cN/tex.

30. The textile cord according to claim 20, wherein a ratio of a final modulus of the textile cord to an initial modulus of the textile cord is less than 4.

31. The textile cord according to claim 20, wherein an initial tensile modulus of the textile cord, measured at 180° C., is greater than 300 cN/tex.

32. The textile cord according to claim 20, wherein a tenacity of the textile cord, measured at 20° C., is greater than 120 cN/tex.

33. The textile cord according to claim 20, wherein a thermal shrinkage of the textile cord after 2 minutes at 185° C., under a pretension of 0.5 cN/tex, is between 0.2% and 2.5%.

34. The textile cord according to claim 20, where a shrinkage force of the textile cord after 2 minutes at 185° C., under constant length and a pretension of 0.5 cN/tex, is between 1 and 2.5 cN/tex.

35. A tyre comprising a composite textile cord for reinforcement, wherein the textile cord is an aramid/polyketone composite textile cord that includes:
at least one aramid multifilament strand; and
at least one polyketone multifilament strand,
wherein the at least one aramid multifilament strand and the at least one polyketone multifilament strand are twisted together,
wherein constituent individual filaments of the at least one aramid multifilament strand are twisted according to a twist factor K₁, and constituent individual filaments of the at least one polyketone multifilament strand are twisted according to a twist factor K₂,
wherein an aramid/polyketone weight ratio is greater than 1.5, and
wherein a K₂/K₁ ratio is greater than 1.10.

36. The tyre according to claim 35, wherein the textile cord is present in a belt or a carcass reinforcement of the tyre.
